(19) United States
(12) Patent Application Publication
(10) Pub. No.: US 2015/0303580 A1
(43) Pub. Date: Oct. 22, 2015

(54) Modular Feed Assembly

(71) Applicant: COMMSCOPE TECHNOLOGIES LLC, Hickory, NC (US)

(72) Inventor: Alastair D. Wright, Edinburgh (GB)

(21) Appl. No.: 14/648,729

(22) PCT Filed: Aug. 22, 2014
(86) PCT No.: PCT/US14/52215

§ 371 Date: Jun. 1, 2015

Related U.S. Application Data
(60) Provisional application No. 61/905,933, filed on Nov. 19, 2013.
(60) Provisional application No. 62/013,098, filed on Jun. 17, 2014.

(51) Int. Cl. H01Q 13/02; H01P 1/04

(52) U.S. Cl. CPC H01Q 13/02; H01Q 13/0283; H01P 1/042

(57) ABSTRACT

In one embodiment, a modular feed assembly for an antenna has (i) a hub adapter for mounting the feed assembly onto the antenna hub and (ii) a distinct waveguide transition configured to be selectively mated to the hub adapter. By providing a modular design, the hub adapter can be selectively used with different waveguide transitions having different frequency characteristics to form feed assemblies for different antennas having different operating frequency ranges. The hub adapter and each waveguide transition have timing features that limit the rotation orientation between the two components to, for example, horizontal and vertical polarizations that are 90 degrees apart. The hub adapter has a resilient compression element that forms an annular seal between the hub adapter and a mated waveguide transition to inhibit RF leakage and keep the two components in place. The hub adapter has openings that allow the compression element to be formed in place.

### CROSS-REFERENCE TO RELATED APPLICATIONS

This application claims the benefit of the filing dates of U.S. provisional application Nos. 61/905,933, filed on Nov. 19, 2013, and 62/013,098, filed on Jun. 17, 2014, the teachings of which are incorporated herein by reference in their entirety.

### BACKGROUND

1. Field of the Invention

The present invention relates to antennas and, more specifically but not exclusively, to feed assemblies for reflector antennas.

2. Description of the Related Art

This section introduces aspects that may help facilitate a better understanding of the invention. Accordingly, the statements of this section are to be read in this light and are not to be understood as admissions about what is prior art or what is not prior art.

Reflector antennas may utilize a feed assembly wherein a sub-reflector is supported proximate the focal point of the reflector dish by a waveguide and dielectric cone. The feed assembly may be coupled to a hub of the reflector antenna by fasteners.

The orientation of the feed assembly may be rotated to select a desired signal polarization, typically in 90-degree increments.

If sealing between the feed assembly and the hub is inadequate, RF leakage between the feed assembly and hub may generate backlobes in the antenna signal pattern, degrading electrical performance of the antenna.

Feed assemblies are typically designed and manufactured in several different operating-frequency-specific embodiments, requiring significant engineering, procurement, materials, manufacturing, and inventory expense.

### BRIEF DESCRIPTION OF THE DRAWINGS

Other embodiments of the invention will become more fully apparent from the following detailed description, the appended claims, and the accompanying drawings in which like reference numerals identify similar or identical elements.

FIG. 1 is a schematic isometric view of a reflector antenna with a modular feed assembly positioned for mating with the hub.

FIG. 2 is a schematic side view of the reflector antenna of FIG. 1, with a partial cut-away to show the seating of the modular feed assembly and the hub.

FIG. 3 is a schematic isometric exploded view of the modular feed assembly of FIG. 1.

FIG. 4 is a schematic side view with partial cut-away of the assembled modular feed assembly of FIG. 1.

FIG. 5 is a schematic proximal end view of the modular feed assembly of FIG. 4.

FIG. 6 is a close-up view of area A of FIG. 4.

FIG. 7 is a schematic isometric proximal end view of the hub adapter of the modular feed assembly of FIG. 4.

FIG. 8 is a schematic angled isometric distal end view of the hub adapter of the modular feed assembly of FIG. 4.

FIG. 9 is a schematic angled isometric distal end view of the transition of the modular feed assembly of FIG. 4.

FIG. 10 is a schematic angled isometric distal end view of an alternative transition and hub adapter for a modular feed assembly.

FIG. 11 is a schematic angled isometric distal end exploded view of another alternative modular feed assembly.

FIG. 12 is a schematic distal end view of the modular feed assembly of FIG. 11.

FIG. 13 is a schematic angled isometric distal end exploded view of another alternative modular feed assembly.

FIG. 14 is a schematic angled proximal end view of the hub adapter of the modular feed assembly of FIG. 13.

FIG. 15 is a schematic angled distal end view of the transition of the modular feed assembly of FIG. 13.

FIGS. 16-27 show different views associated with another alternative modular feed assembly.

### DETAILED DESCRIPTION

A significant cost efficiency may be realized by isolating portions of a feed assembly that are frequency specific, to reduce the number of unique elements required to manufacture a family of feed assemblies for a wide range of operating frequencies. Further, by reducing the size of such frequency-specific components, cost-efficient polymer materials and component configurations suitable for fabrication via injection molding may be applied to a greater portion of the assembly, further reducing material and fabrication costs. Polymer materials also enable simplified insertion-connect-type attachment/alignment and/or integral-seal arrangements with improved assembly and/or sealing characteristics.

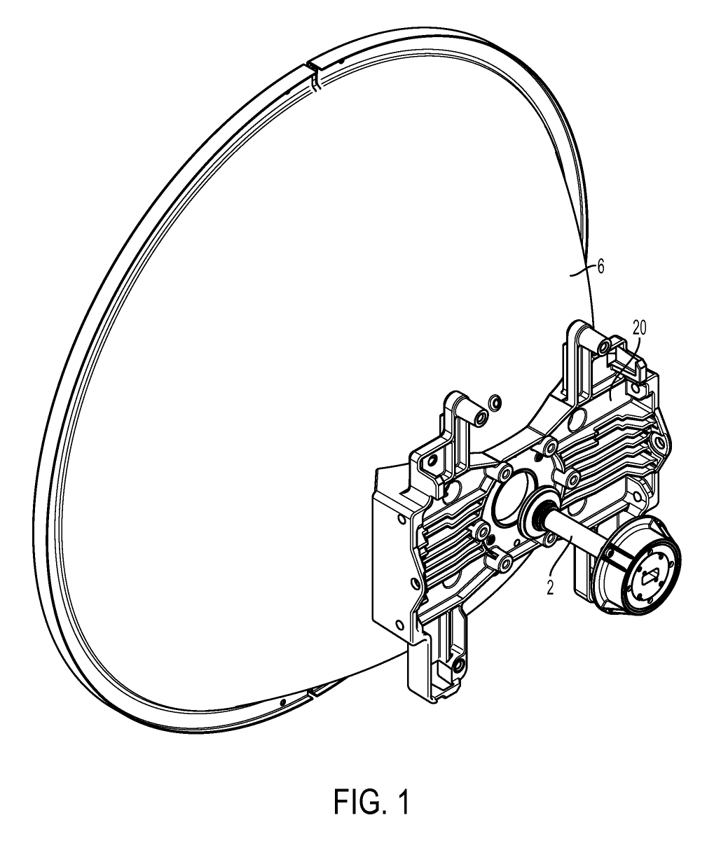

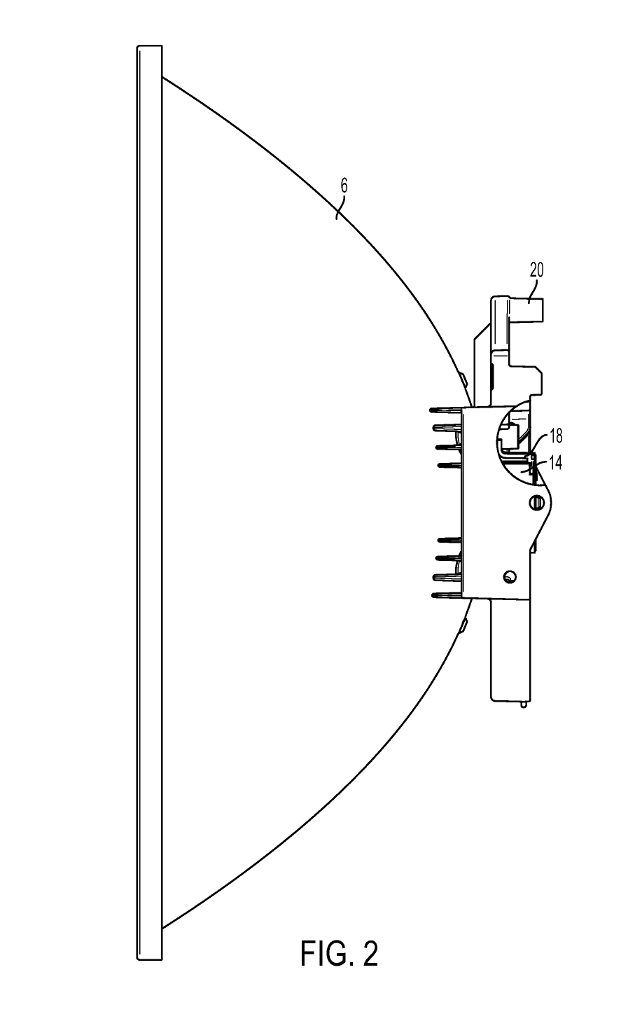

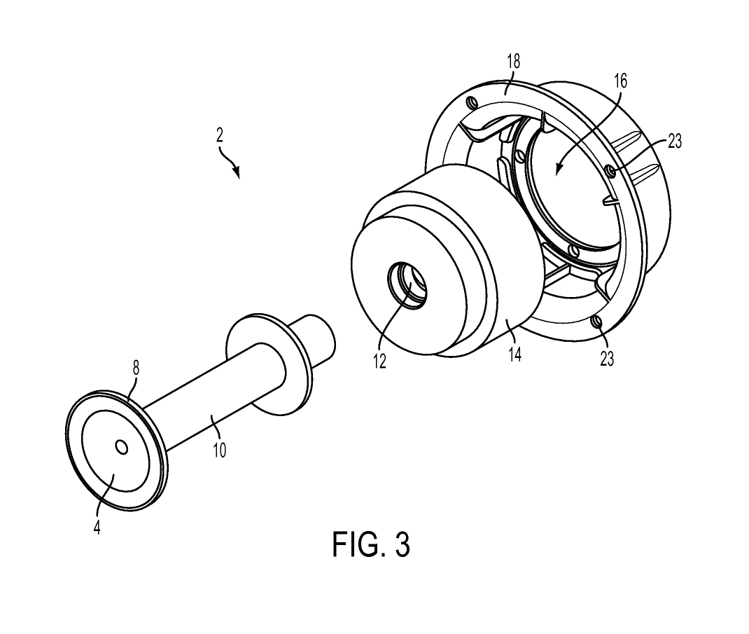

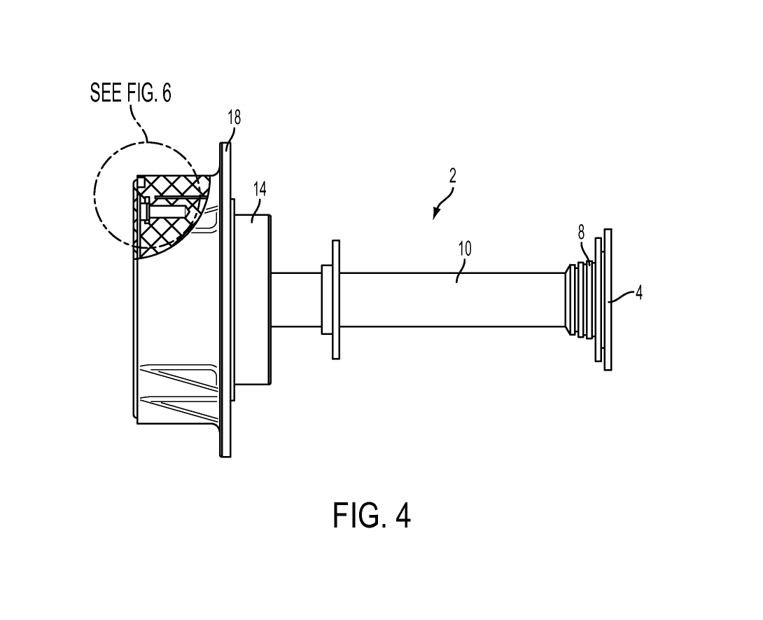

As shown in FIGS. 1-9, an exemplary embodiment of a modular feed assembly 2 supports a sub-reflector 4 proximate a focal point of a reflector dish 6. As best shown in FIGS. 3-4, the subreflector 4 is coupled to a dielectric block 8 provided at a distal end of a waveguide 10. The proximal end of the waveguide 10 seats within the RF bore 12 of a transition 14. The transition 14 seats within the transition bore 16 of a hub adapter 18. The hub adapter 18 is dimensioned to secure the modular feed assembly 2 with respect to a hub 20 (FIGS. 1-2) of the reflector dish 6 via fasteners applied through holes 23.

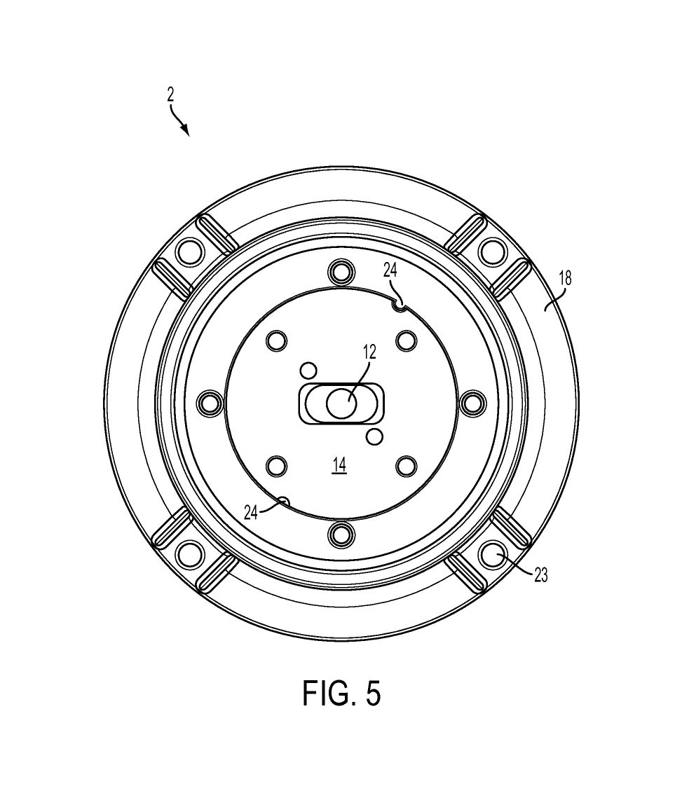

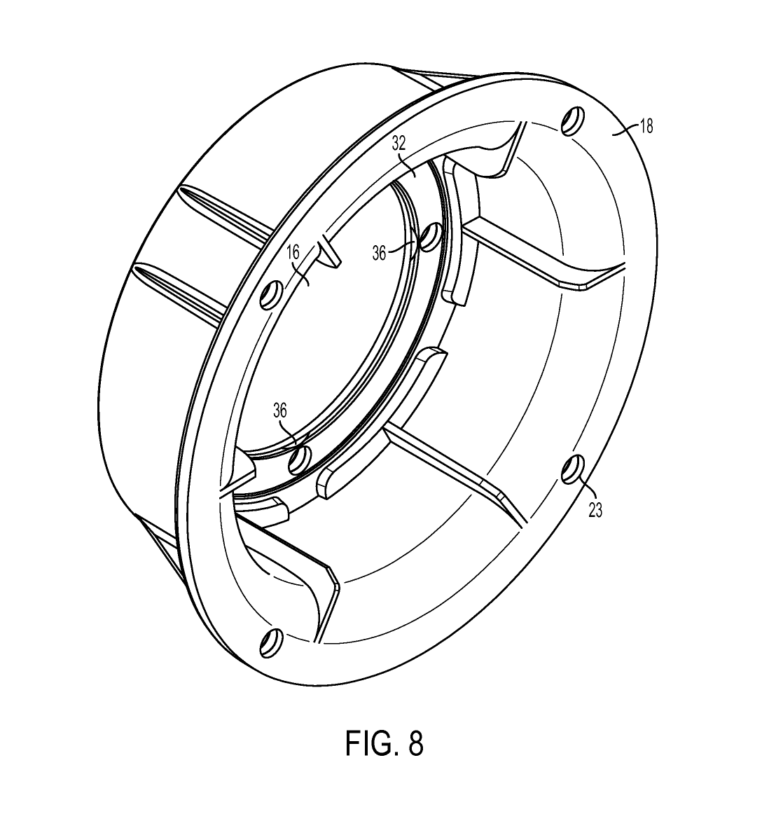

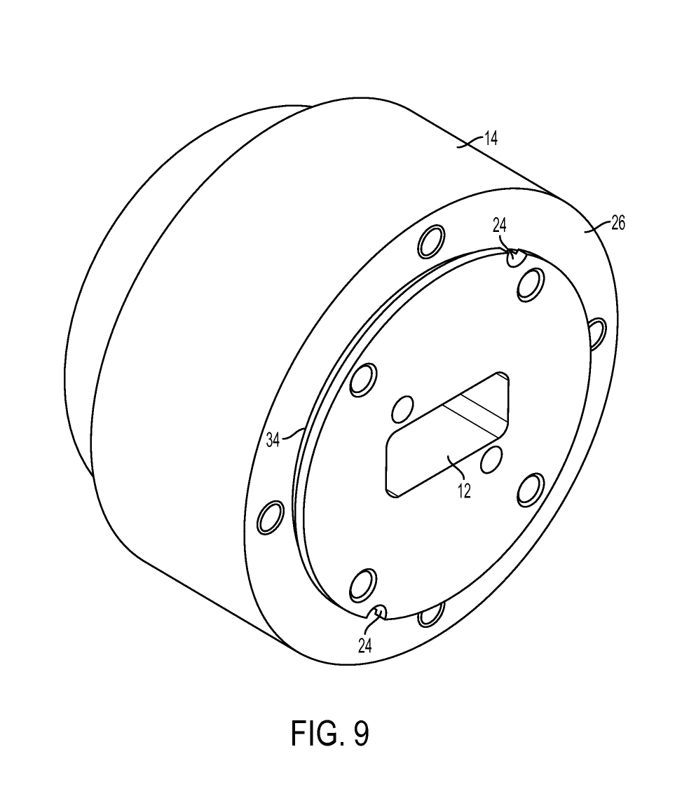

The RF bore 12 of the transition 14 provides frequency-specific impedance matching to efficiently launch/receive RF signals into/from the waveguide 10 and to/from downstream equipment coupled to the transition 14, such as transceivers or the like. The RF bore 12 may include, for example, a waveguide transition from a circular waveguide (FIG. 3) to a rectangular waveguide (FIGS. 5 and 9). The precision features of the RF bore 12 may be formed, for example, by machining and/or casting the transition 14 from metal material. To minimize the amount of metal material required for the transition 14, the hub adapter 18 is applied to provide structure for supporting the transition 14 and thereby the sub-reflector 4 with respect to the reflector dish 6 and any downstream equipment.

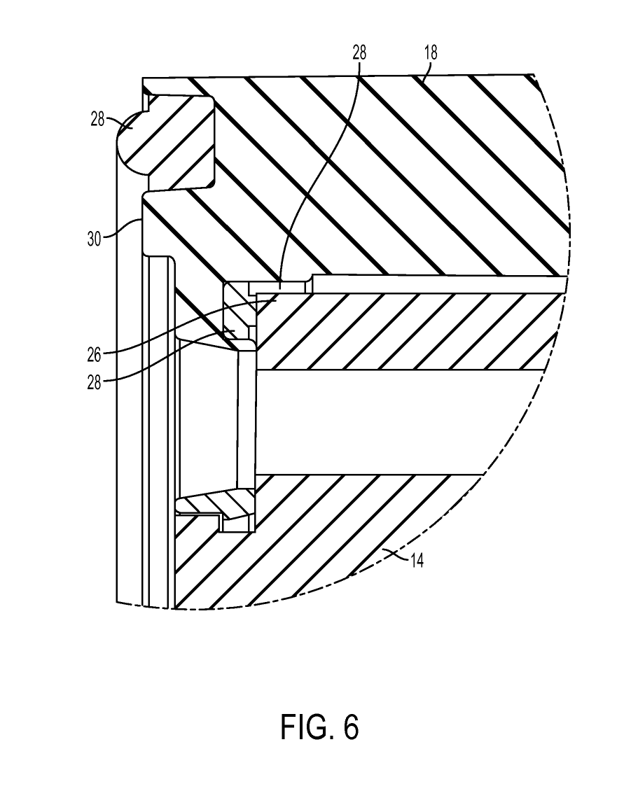

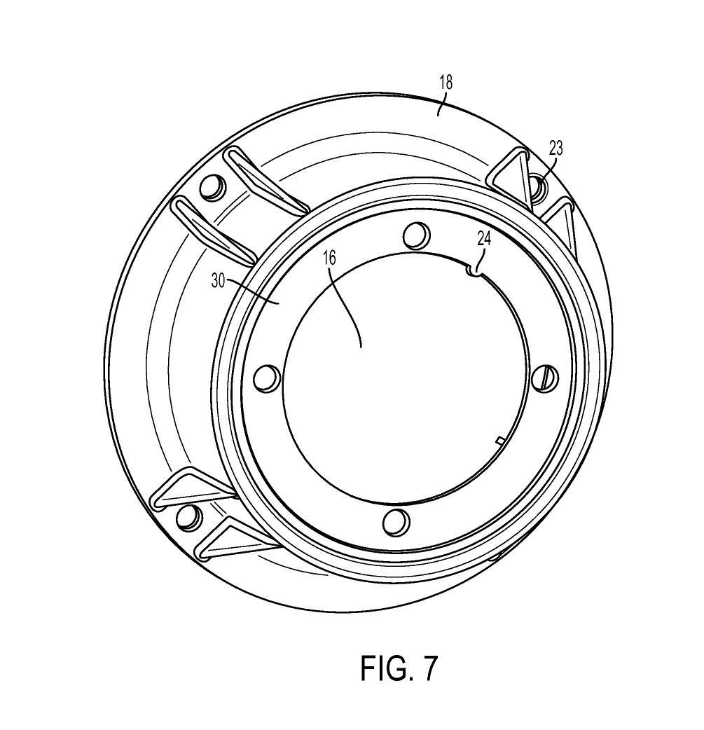

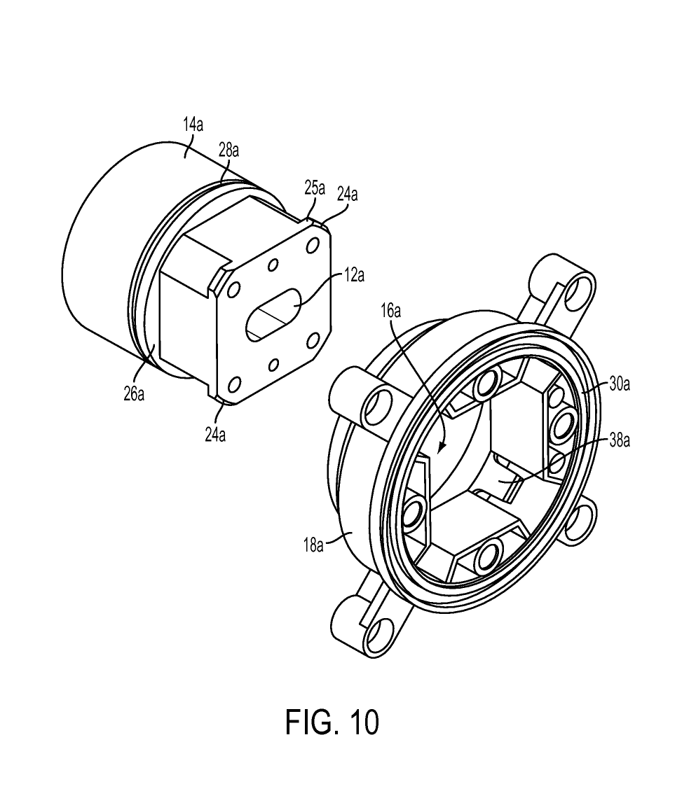

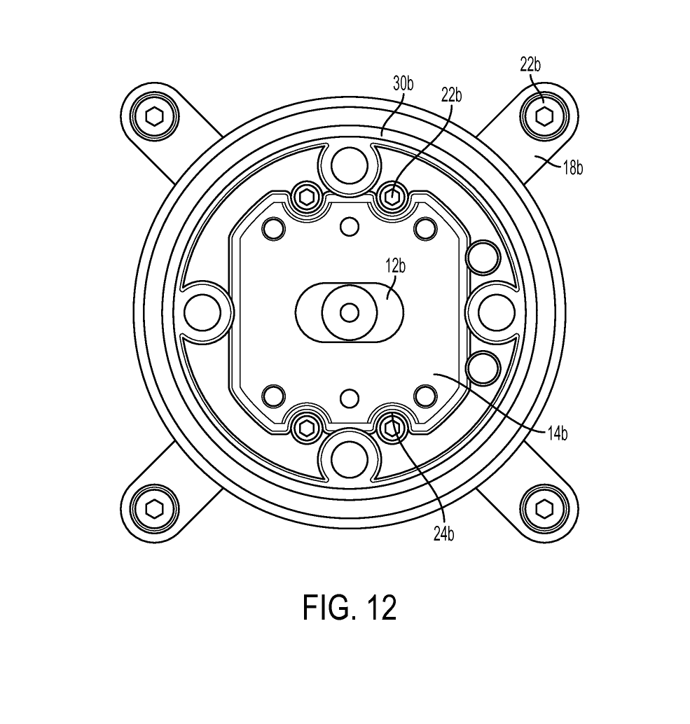

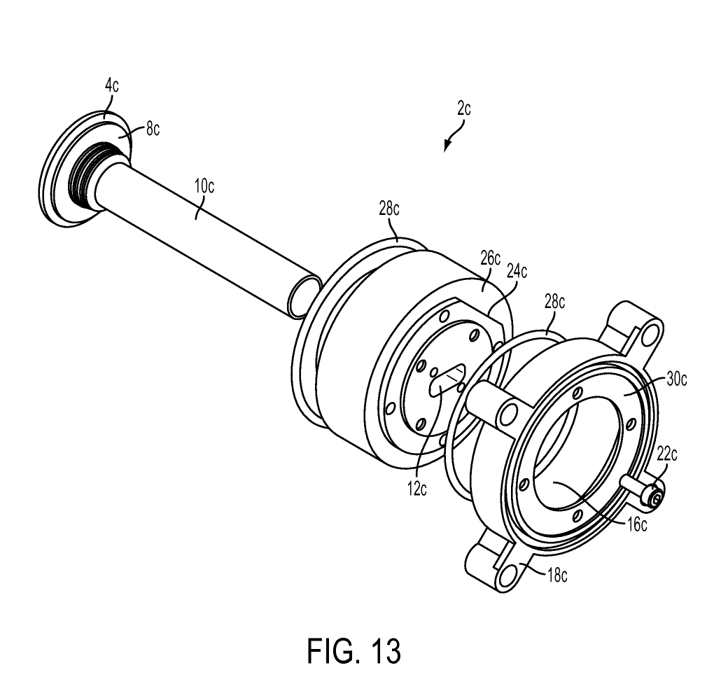

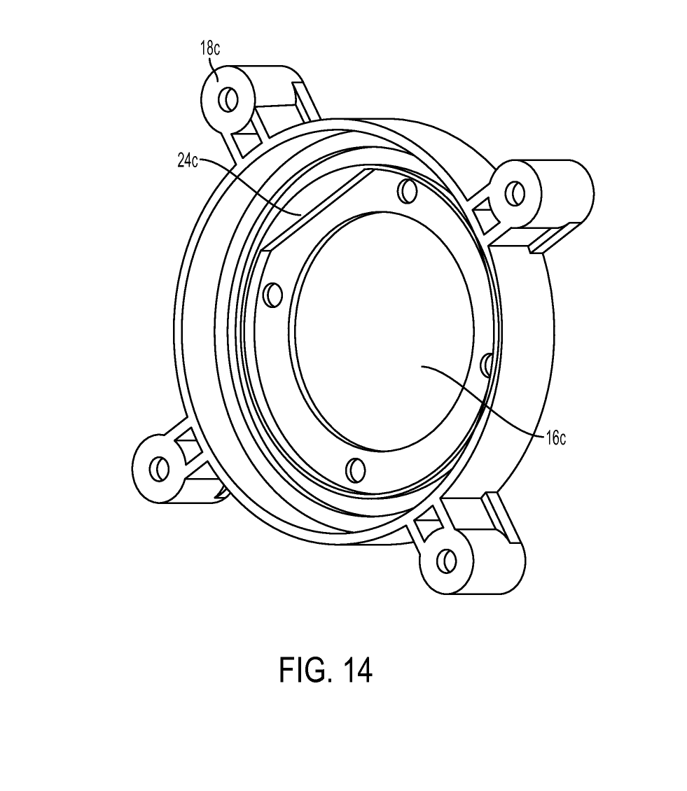

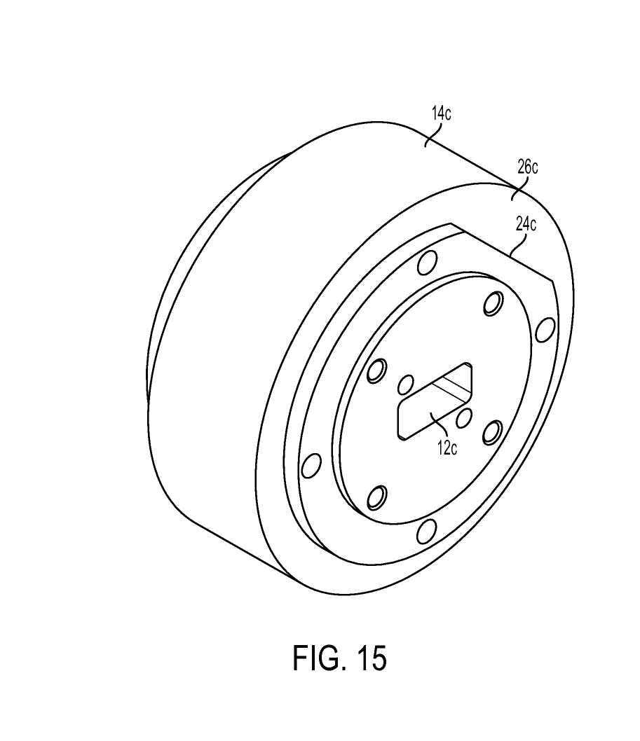

As best shown in FIGS. 3, 7, and 8, the transition 14 seats within a transition bore 16 of the hub adapter 18. A timing feature 24 (FIGS. 5 and 7) on the proximal end of the transition 14, such as a tab or slot may key with a corresponding tab or slot of the hub adapter 18 to key a rotation angle of the transition 14 with respect to the hub adapter 18. Providing multiple timing features 24, for example, spaced apart by 90 degrees, enables selection of an initial polarization alignment of the modular feed assembly 2 with respect to the hub adapter 18, which may itself be rotated with respect to the hub 20 for polarity selection. In the three alternative embodiments of FIGS. 10, 11-12, and 13-15, a non-circular cross-section of the transition 14a,b,c between a seat shoulder 26a,b,c of the transition 14a,b,c and a proximal end of the transition 14a,b,c may also provide timing-feature functionality. The seat shoulder 26 (FIGS. 6 and 9) also enables the proximal end of the transition 14 to extend through the hub adapter 18 for ease of coupling with downstream equipment.

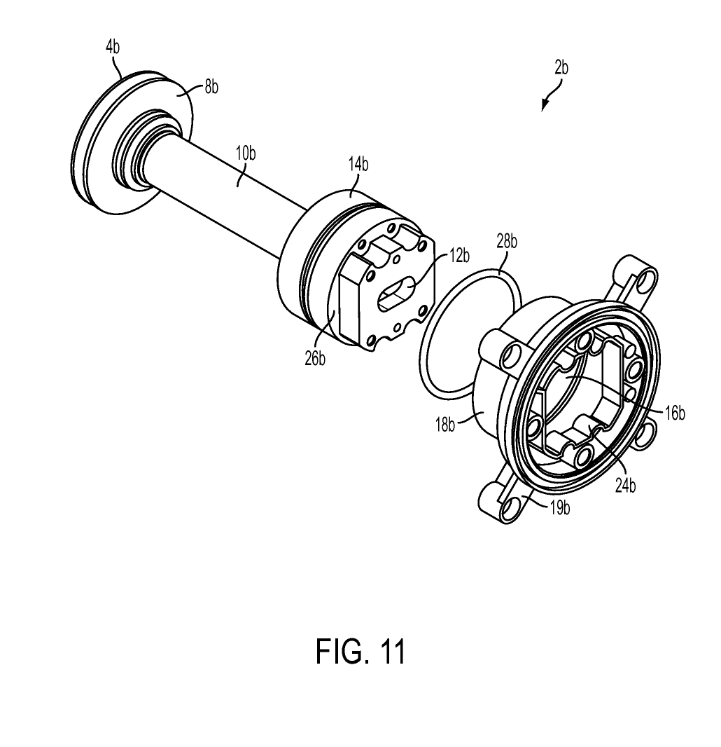

The engagement between the transition 14 and hub adapter 18 may be environmentally and/or RF sealed by application of one or more seals 28 (FIG. 6) therebetween. An RF-absorbing or -shielding material seal 28 may engage, for example, an outer diameter of the transition 14. An environmental seal 28, such as an elastomer gasket or the like, may be applied, for example, to seal against the proximal end of the transition 14. Additional seals 28 may be provided, for example, at a proximal end face 30 (FIGS. 6 and 7) of the hub adapter 18 to seal between the hub adapter 18 and downstream equipment. The seals 28 may be formed in place upon the hub adapter 18 as a second shot of an injection-molding process applied to form the hub adapter 18, for example, from polymer material. Provided integral with the hub adapter 18, these seals 28 eliminate a potential leakage path around the backside of each seal and reduce the total number of separate parts of the assembly, which may improve the seal effect and reduce potential assembly errors. Alternatively, seals 28a,b may be applied, for example, as shown in FIGS. 10 and 11, around an outer diameter of the transition 14a,b, for example, seated in a seal groove of the transition 14a,b outer diameter.

The transition 14 to hub adapter 18 interconnection may include a snap-fit functionality to retain the transition 14 within the transition bore 16, for ease of initial alignment and/or retention in place, for example, until downstream equipment is coupled to the transition 14, clamping the transition 14 across the hub adapter 18. To prevent excess fastener tightening from damaging the hub adapter 18 and/or to provide an initial amount of axial play for engaging a snap-fit interconnection, the seat shoulder 26 of the transition 14 may seat against an anti-crush ring 32 provided on the hub adapter 18, for example, as shown in FIG. 8.

Retention features for snap-fit interconnection may include a retention groove 34 (FIG. 9) of the transition 14 outer diameter, which receives inward projecting tabs 36 (FIG. 8) of the hub adapter 18. Alternatively, the retention feature may be provided as an inward-biased spring tab 38a adapted to engage a retention lip 25a of the transition 14a, as shown for example in FIG. 10.

One skilled in the art will appreciate that providing the frequency-specific transition 14 enables fabrication of frequency-specific antenna families from a common pool of components, wherein the only unique component between a pair of antennas, each optimized for separate operating frequencies, is the easily exchanged transition 14. Further, the reduction in the size and complexity of the transition 14 may provide a materials and manufacturing efficiency that enables greater use of polymers and injection-molding fabrication, instead of machining, for the remainder of the feed assembly module, which may also enable further advantageous features, such as snap-fit retention arrangements and/or integral seals 28.

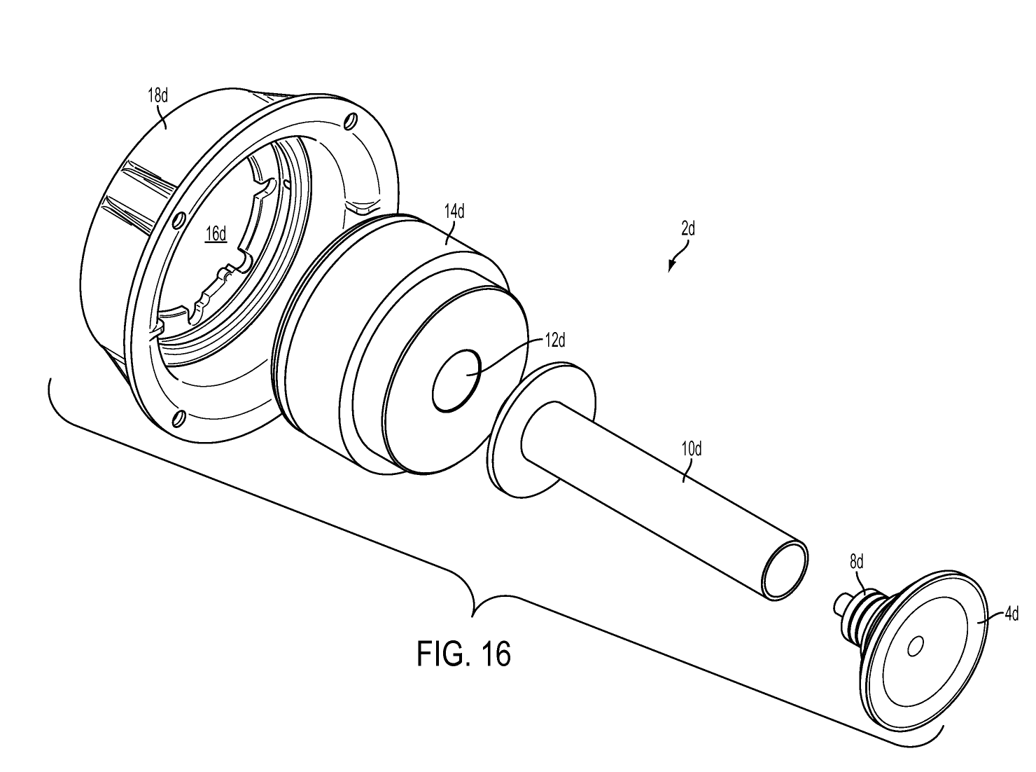

FIGS. 16 and 17 show exploded perspective front and back views, respectively, of an alternative modular feed assembly 2d comprising sub-reflector 4d connected to dielectric block 8d, which mates to cylindrical waveguide 10d, which mates to RF bore 12d of RF transition 14d, and hub adapter 18d having transition bore 16d, which receives and mates to RF transition 14d. When the modular feed assembly 2d is assembled, the sub-reflector, dielectric block, and cylindrical waveguide can be inserted through an opening in the hub of an antenna dish, such as hub 20 of FIG. 1, and the hub adapter 18d can be mated to the hub to secure the feed assembly 2d in place.

FIG. 18 shows a perspective front view of the RF transition 14d. RF bore 12d has a circular cross section at the back side of the RF transition (see FIG. 16) and a substantial rectangular cross section at the front side the RF transition (see FIG. 18). As shown in FIG. 18, the front side of RF transition 14d has four tapped screw holes 40d (90 degrees apart), two timing slots 42d (180 degrees apart), and a circumferential groove 44d, all of which assist in the mating of the RF transition to hub adapter 18d and all of which will be described further below.

FIG. 18 also shows four holes 46d separated by 90 degrees and two holes 48d separated by 180 degrees on the front side of RF transition 14d. Holes 46d are used to mount additional components (not shown) typically used in remote radio fitment, and holes 48d are tooling jig holes.

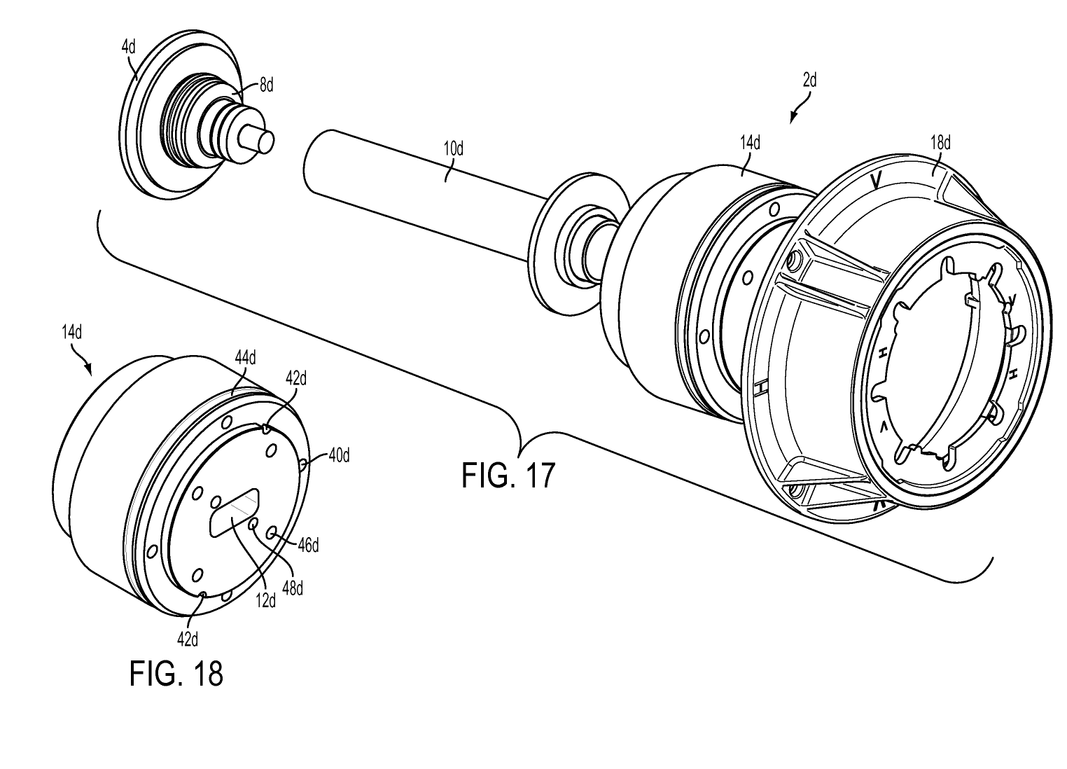

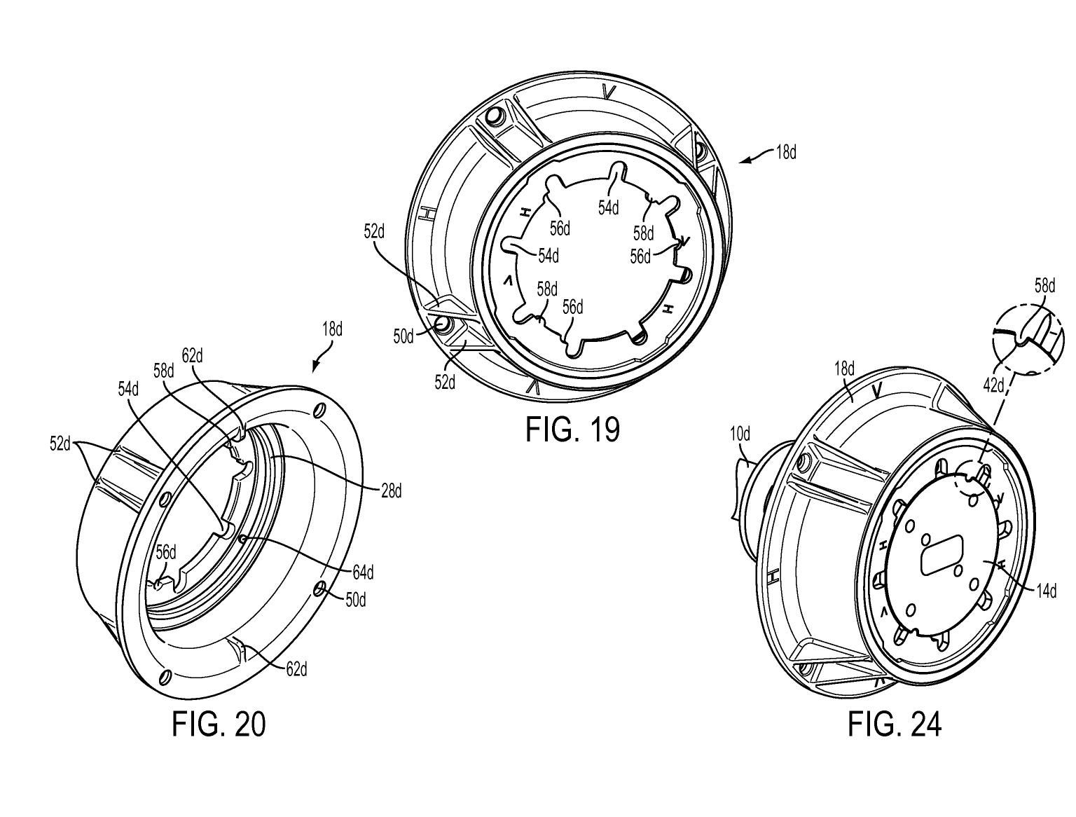

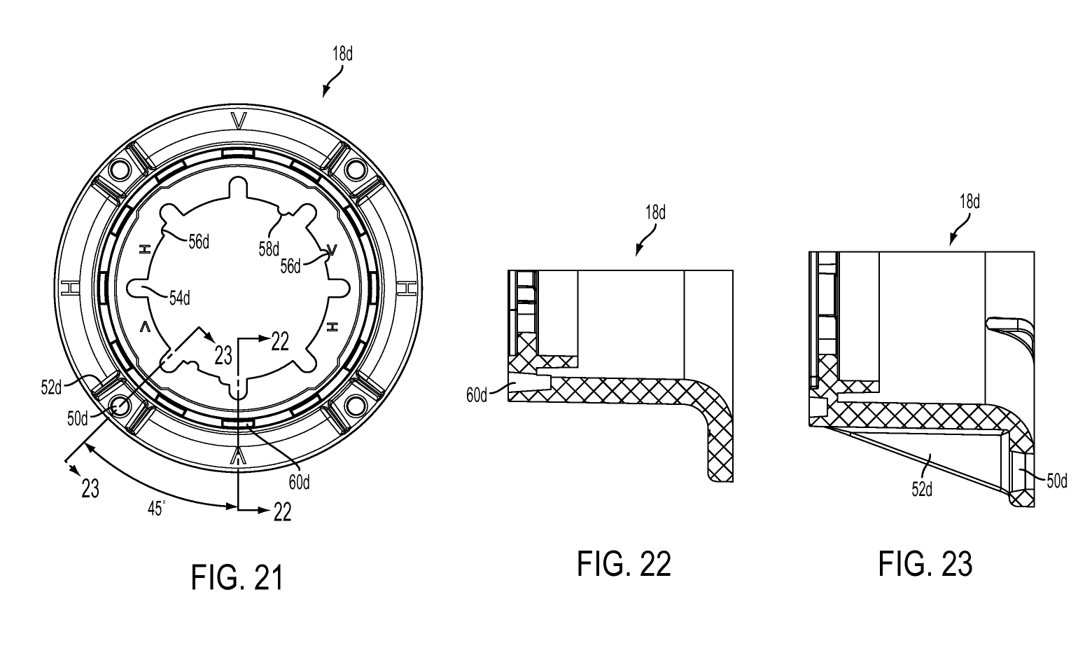

FIGS. 19 and 20 show perspective front and back views, respectively, of hub adapter 18d. FIG. 21 shows a plan front view of hub adapter 18d, and FIGS. 22 and 23 show two different cross-sectional views of hub adapter 18d along cut lines C-C and D-D of FIG. 21, respectively.

The back side of hub adapter 18d has four untapped screw holes 50d, separated by 90 degrees and located between pairs of strengthening ribs 52d, for mating the hub adapter (and the entire feed assembly 2) to, for example, hub 20 of FIG. 1.

The front side of hub adapter 18d has eight screw slots 54d separated by 45 degrees, three injection points 56d separated by 120 degrees, and two timing lugs 58d separated by 180 degrees. The front side of the hub adapter also has twelve passages 60d separated by 30 degrees.

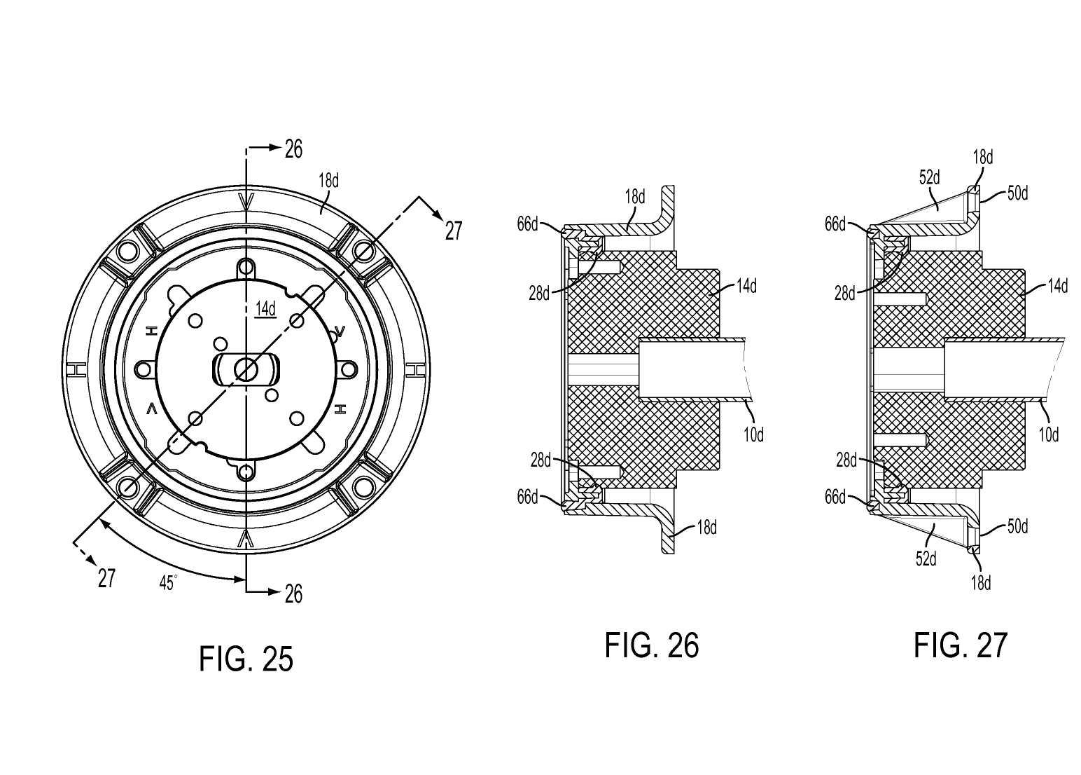

FIGS. 24 and 25 shows perspective and plan front views of the RF transition 14d positioned within and mated to the hub adapter 18d. FIGS. 26 and 27 show two different cross-sectional views of the RF transition/hub adapter assembly along cut lines A-A and B-B of FIG. 25, respectively.

As shown in the FIGS. 24 and 25, timing lugs 58d of RF transition 14d mate with timing slots 42d of hub adapter 18d. Because the two timing lugs 58d and two timing slots 42d are both separated by 180 degrees, there are only two different orientations in which RF transition 14d and hub adapter 18d can be configured to one another, and those two orientations are identical. As shown in FIG. 25, when mated together, four of the eight screw slots 54d of hub adapter 18d line up with the four screw holes 40d of RF transition 14d, thereby enabling four screws (not shown) to be used to secure the RF transition and hub adapter together. Although the other four screw slots 54d of hub adapter 18d are not used with RF transition 14d, they do enable hub adapter 18d to be used with other RF transitions (e.g., for other RF frequencies) having different timing structures that support different orientations between the RF transition and hub adapter 18d.

As shown, for example, in FIG. 21, hub adapter 18d has the letters H and V, which respectively indicate two different configurations, i.e., horizontal and vertical, respectively, in which the feed assembly 2d can be mated to the antenna hub 20 of FIG. 1. In the horizontal configuration, in which the letters H appear at the left and right sides of the hub adapter 18d (i.e., 3 and 9 o'clock positions), the longer sides of the rectangular opening 12d in the RF transition 14d are oriented horizontally (as indicated in FIG. 1). In the vertical configuration, in which the letters V appear at the left and right sides of the hub adapter 18d, the longer sides of the rectangular opening 12d in the RF transition 14d are oriented vertically. Note that, because there are four screw holes 50d in hub adapter 18d and four corresponding screw holes in hub 20, there are actually two identical horizontal configurations and two identical vertical configurations in which the feed assembly 2d can be mated to the hub.

As shown in FIG. 20, hub adapter 18d has a relatively resilient (e.g., elastomeric) annular compression element (i.e., gasket) 28d that mates with groove 44d in RF transition 14d to form a watertight seal between the hub adapter and the RF transition to prevent moisture from passing therebetween.

In one implementation, the gasket 28d is pre-formed by injecting an uncured elastomer into the injection points 56d and passages 60d on the front side of hub adapter 18d, while the hub adapter is mated to a special injection fixture (not shown) and then curing the elastomer before removing the hub adapter from the injection fixture. The two structures 62d separated by 180 degrees are alignment features for mounting the hub adapter to such an injection fixture. Recess 64d, shown in FIG. 20, is an injection gate that ensures that excess elastomeric material is sub flush to the gasket 28d and does not interfere with its sealing function. The hub adapter 18d can then be mated with the RF transition 14d by applying force until the gasket 28d engages groove 44d in the RF transition.

As shown in FIGS. 26 and 27, the injected elastomer forms both the annular gasket 28d on the inner cylindrical surface of the hub adapter 18d as well as an annular gasket 66d on the front face of the hub adapter. This second annular gasket 66d helps to form a watertight seal between the hub adapter 18d and additional components (not shown) typically used in radio fitment and mated to the feed assembly 2d.

Hub adapter 18d is made from a relatively rigid material, such as a suitable metal, such as, but not limited to, copper or aluminum, or a suitable plastic such as, but not limited to, polycarbonate, polyester, polybutylene terephthalate (PBT), acrylonitrile butadiene styrene (ABS), or polystyrene. Depending on the material used, hub adapter 18d may be made using a suitable technique such as, but not limited to, casting, pressing, or injection molding. RF transition 14d is made of a suitable metal.

Where, in the foregoing description, reference has been made to materials, ratios, integers, or components having known equivalents, then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

Unless explicitly stated otherwise, each numerical value and range should be interpreted as being approximate as if the word “about” or “approximately” preceded the value or range.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

1. An article of manufacture comprising a modular feed assembly for an antenna, the feed assembly comprising:
a hub adapter configured to mount the feed assembly onto a hub of the antenna;
a waveguide transition forming a component distinct from the hub adapter and configured to be selectively mated to the hub adapter, wherein:
the waveguide transition provides a transition from a first waveguide having a first cross-section to a second waveguide having a second cross-section different from the first cross-section; and
the hub adapter and the waveguide transition have structures that prevent rotation of the waveguide transition about its longitudinal axis with respect to the hub adapter after the waveguide transition is mated to the hub adapter.

2. The article of claim 1, wherein:
the first cross-section of the first waveguide is rectangular; and
the second cross-section of the second waveguide is circular.

3. The article of claim 1, wherein the structures comprise one or more timing features that limit a rotational orientation between the hub adapter and the waveguide transition to one of a fixed number of possible rotational orientations.

4. The article of claim 3, wherein the one or more timing features limit the possible rotational orientations to two rotational orientations that are separated by a 180-degree rotation.

5. The article of claim 1, wherein the hub adapter is configured to selectively mate with different waveguide transitions having different frequency characteristics, such that the hub adapter can selectively be used to form different feed assemblies for different antennas having different operating frequency ranges.

6. The article of claim 5, wherein the different waveguide transitions have identical mating interfaces for mating with the hub adapter.

7. The article of claim 5, wherein, for first and second waveguide transitions, at least one of the first and second cross-sections of the first and second waveguides corresponding to the first waveguide transition is different from a corresponding at least one of the first and second cross-sections of the first and second waveguides corresponding to the second waveguide transition.

8. The article of claim 1, wherein the hub adapter comprises a resilient compression element that forms an annular seal with the waveguide transition that inhibits RF leakage from the antenna.

9. The article of claim 8, wherein the hub adapter comprises one or more passages that allow an elastomeric material to flow through the hub adapter to form the compression element.

10. The article of claim 9, wherein the one or more passages allow the elastomeric material to flow through the hub adapter to form the compression element after the hub adapter is mated to the waveguide transition.

11. The article of claim 1, wherein the article of manufacture is the feed assembly.

12. The article of claim 1, wherein the article of manufacture is the feed assembly secured to the hub.

13. The article of claim 1, wherein the article of manufacture is the antenna.

14. A method for forming an article of manufacture comprising a modular feed assembly for an antenna, the method comprising:
(a) providing a hub adapter configured to mount the feed assembly onto a hub of the antenna; and
(b) mating a waveguide transition to the hub adapter, wherein:
the waveguide transition forms a component distinct from the hub adapter;
the waveguide transition provides a transition from a first waveguide having a first cross-section to a second waveguide having a second cross-section different from the first cross-section; and
the hub adapter and the waveguide transition have structures that prevent rotation of the waveguide transition about its longitudinal axis with respect to the hub adapter after the waveguide transition is mated to the hub adapter.

15. The method of claim 14, wherein:
the structures comprise one or more timing features that limit a rotational orientation between the hub adapter and the waveguide transition to one of a fixed number of possible rotational orientations; and
step (b) comprises mating the waveguide transition to the hub adapter with a selected one of the possible rotational orientations.

16. The method of claim 14, wherein the hub adapter is configured to selectively mate with different waveguide transitions having different frequency characteristics, such that the hub adapter can selectively be used to form different feed assemblies for different antennas having different operating frequency ranges.

17. The method of 14, wherein the hub adapter comprises a resilient compression element that forms an annular seal with the waveguide transition that inhibits RF leakage from the antenna.

18. The method of claim 17, wherein:
the hub adapter comprises one or more passages; and
the method comprises flowing an elastomeric material through the passages in the hub adapter to form the compression element.

19. The method of claim 18, wherein step (b) comprises flowing the elastomeric material through the passages in the hub adapter to form the compression element after the hub adapter is mated to the waveguide transition.
